(19) United States
(12) Patent Application Publication
(10) Pub. No.: US 2014/0168097 A1
(43) Pub. Date: Jun. 19, 2014

(54) MULTI-TOUCH GESTURE FOR MOVEMENT OF MEDIA

(71) Applicant: MOTOROLA MOBILITY LLC, Libertyville, IL (US)

(72) Inventor: Sung-Woo Oh, Seocho-Gu (KR)

(73) Assignee: Motorola Mobility LLC, Libertyville, IL (US)

(21) Appl. No.: 13/716,288

(22) Filed: Dec. 17, 2012

(51) Int. Cl. G06F 3/01; G06F 3/041

(52) U.S. Cl. CPC G06F 3/017; G06F 3/041
USPC 345/173

(57) ABSTRACT

In one embodiment, a method includes detecting, by an electronic device, a multi-touch gesture on a touch input area associated with the electronic device. The multi-touch gesture is moved across the touch input area. The method determines a distance that the multi-touch gesture is moved across the touch input area and also determines a speed of movement based on the determined distance. Then, media displayed in the electronic device is moved at the determined speed of movement based on detecting the multi-touch gesture on the touch input area. In another embodiment, a method causes movement of media being displayed in the electronic device for the number of units based on analyzing of a sequence of touches.

### BACKGROUND

When a user is watching a video, the user may want to seek to a different location in the video. Typically, an electronic device, such as a mobile device or computer, may be playing the video in a user interface. The user interface includes a button icon or status bar that is used to show an elapsed time of the video on a timeline. To seek to a different time, the user may use a finger to touch the button icon on the user interface. The user can then move his/her finger to slide the button icon to another position on the timeline. This seeks to a corresponding time in the video.

In some cases, the button icon may be relatively small compared to a user's finger. For example, when watching the video in a mobile device, such as a smartphone or a tablet, the size of the screen limits the size of the button icon. This may make it hard for a user to move the button icon to a desired position that the user wants to seek to in the video. Also, a user may not be able to seek in small granularities of time due to the size of the screen. For example, if the user wants to seek one second ahead, it is very hard for the user to move his/her finger such a small distance to cause the video to seek one second ahead.

### BRIEF DESCRIPTION OF THE DRAWINGS

FIG. 1 depicts an example of an electronic device for analyzing multi-touch gestures for movement of media according to one embodiment.

FIGS. 2A-2C depict examples of a multi-touch gesture for causing movement of media according to one embodiment.

FIGS. 3A-3C depict examples for causing movement of media in a different direction from that of FIGS. 2A-2C according to one embodiment.

FIGS. 4A-4C depict an example of a multi-touch gesture for moving media a number of units according to one embodiment.

FIGS. 5A-5C depict another example of using a multi-touch gesture to move the media a number of units according to one embodiment.

FIGS. 6A-6C depict an example for performing scrolling of a document in an upward direction according to one embodiment.

FIGS. 7A-7C depict another example of a sequence of a multi-touch gesture used to indicate a downward direction of scrolling according to one embodiment.

FIG. 8 depicts a simplified flowchart of a method for analyzing multi-touch gestures according to one embodiment.

FIG. 9 depicts an example of a result of performing one of the multi-touch gestures shown in FIG. 2A-2C or 3A-3C according to one embodiment.

FIG. 10 depicts a result of a multi-touch gesture shown in FIGS. 4A-4C, 5A-5C, 6A-6C, and 7A-7C according to one embodiment.

### DETAILED DESCRIPTION

Described herein are techniques for a system to analyze multi-touch gestures for movement of media. In the following description, for purposes of explanation, numerous examples and specific details are set forth in order to provide a thorough understanding of particular embodiments. Particular embodiments as defined by the claims may include some or all of the features in these examples alone or in combination with other features described below, and may further include modifications and equivalents of the features and concepts described herein.

In one embodiment, a method includes detecting, by an electronic device, a multi-touch gesture on a touch input area associated with the electronic device. The multi-touch gesture is moved across the touch input area. The method determines a distance that the multi-touch gesture is moved across the touch input area and also determines a speed of movement based on the determined distance. Then, media displayed in the electronic device is moved at the determined speed of movement based on detecting the multi-touch gesture on the touch input area.

In another embodiment, a method detects a first touch of a first object on a touch input area associated with an electronic device and detects a second touch of a second object on the touch input area associated with the electronic device. A sequence of touches received from the first object and the second object is determined and analyzed to determine a number of units. Then, the method causes movement of media being displayed in the electronic device for the number of units based on analyzing of the sequence.

In one embodiment, an apparatus is provided comprising: one or more computer processors; and a non-transitory computer-readable storage medium comprising instructions that, when executed, control the one or more computer processors to be configured for: detecting a multi-touch gesture on a touch input area device, wherein the multi-touch gesture is moved across the touch input area; determining a distance that the multi-touch gesture is moved across the touch input area; determining a speed of movement based on the determined distance; and causing movement of media displayed at the determined speed of movement based on detecting the multi-touch gesture on the touch input area.

In one embodiment, an apparatus is provided comprising: one or more computer processors; and a non-transitory computer-readable storage medium comprising instructions that, when executed, control the one or more computer processors to be configured for: detecting a first touch of a first object on a touch input area; detecting a second touch of a second object on the touch input area; determining a sequence of touches received from the first object and the second object; analyzing the sequence of touches to determine a number of units; and causing movement of media being displayed for the number of units based on analyzing of the sequence.

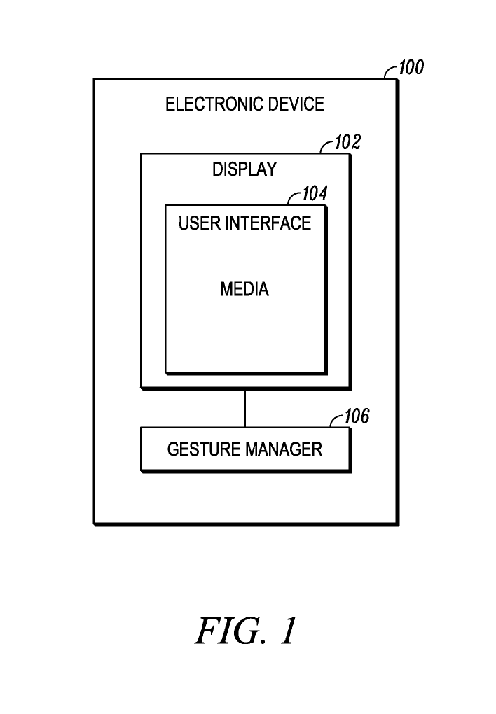

FIG. 1 depicts an example of an electronic device 100 for analyzing multi-touch gestures for movement of media according to one embodiment. Electronic device 100 may be any computing device, such as a mobile device including a smartphone, a cellular phone, a tablet device, and a laptop, or various other computing devices including desktop computers and televisions.

Electronic device 100 includes a display 102 that can display media within a user interface (UI) 104. For example, the media may include video, audio, or a document. In one example, user interface 104 may be playing a video, such as a movie or television show. Additionally, user interface 104 may be playing just audio, such as a song that is being output by electronic device 100. The document may include any type of information that can be scrolled. For example, a document may be a list of information that can be scrolled (e.g., a word processing document or a list of songs or videos), a web page, or any other information displayed in user interface 104.

A gesture manager 106 detects a multi-touch gesture on user interface 104 (or display 102). When the term user interface 104 is used, it will be recognized that user interface 104 may be displayed in portions of display 102 or entirely in display 102. Also, although a multi-touch gesture is discussed as being on user interface 104, the multi-touch gesture may be received on any touch input area associated with electronic device 102, such as on a mouse pad or another input device.

In one embodiment, gesture manager 106 analyzes a multi-touch gesture received on user interface 104 and determines a distance that the multi-touch gesture moves in a direction across user interface 104. Depending on the distance, gesture manager 106 determines a different speed of movement for the media. For example, the speed of a seek operation for a video may be different depending on the amount of distance the multi-touch gesture is moved across user interface 104. Additionally, in another example, the speed of scrolling for a document displayed on user interface 104 may be different depending on the distance the multi-touch gesture is moved across user interface 104.

In another example, the multi-touch gesture may include a sequence of touches that cause movement of the media for a pre-defined amount. For example, the sequence may be touching a first object, such as a finger, on user interface 104, touching a second object, such as a second finger, on user interface 104, removing one of the first object or the second object, and re-touching the one of the first object or the second object on user interface 104. For example, the user touches user interface 104 with both fingers, removes one finger, and then places the same finger down again to touch user interface 104. It should be noted other touch sequences may be appreciated, such as re-touching the one of the first object or the second object may not be necessary or additional touches may be accepted by electronic device 100. In this multi-touch gesture, the user may place the first object and the second object on user interface 104, but not slide the first object and the second object across user interface 104. Once gesture manager 104 detects the sequence, gesture manager 106 may then cause movement of the media for at least a unit of movement. For example, gesture manager 106 may cause a video to seek forward or backward one second or a list to be scrolled by one unit.

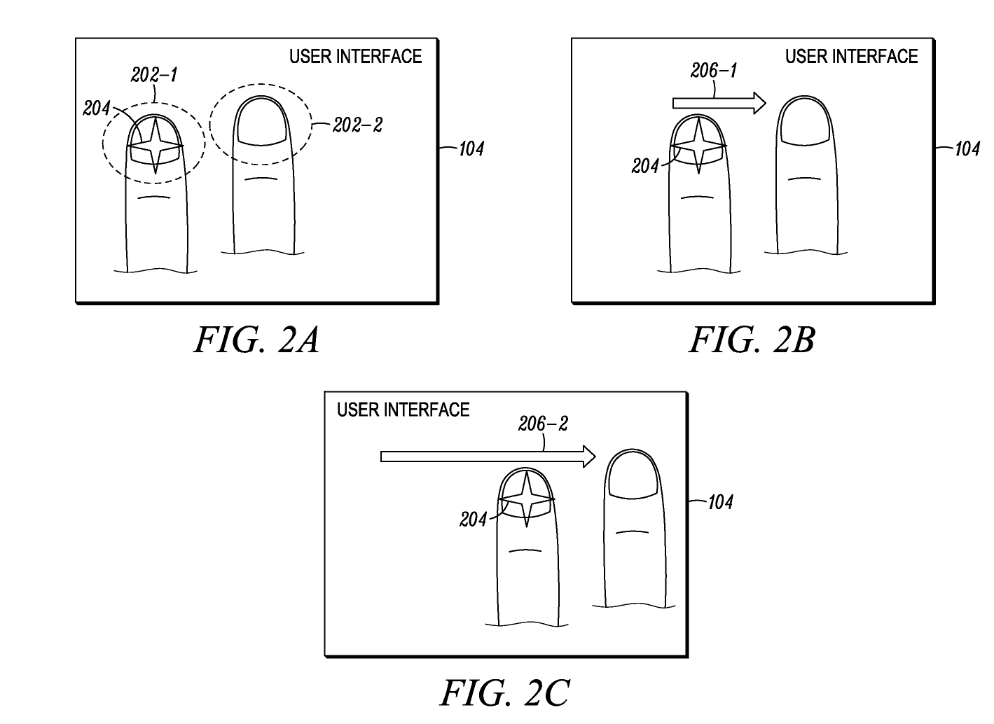

FIGS. 2A-2C depict examples of a multi-touch gesture for causing movement of media according to one embodiment. In FIG. 2A, a user has touched user interface 104 using a first finger and a second finger. Although fingers will be discussed as performing the touching, other objects may be used, such as a stylus. Gesture manager 106 may detect a touch on user interface 104, which is shown in FIG. 2A by a first area 202-1 and a second area 202-2 on user interface 104.

A user may then move the two fingers in a direction across user interface 104. FIGS. 2B and 2C depict two different ways a user can move the two fingers across user interface 104. For example, FIG. 2B depicts the movement of the two fingers in a direction to the right for a first distance shown at 206-1 according to one embodiment. FIG. 2C depicts another example of a user moving the two fingers across user interface 104 for a second distance shown at 206-2 according to one embodiment. The difference between the movement in FIGS. 2B and 2C is that the second distance the fingers are moved in FIG. 2C is greater than the first distance the fingers are moved in FIG. 2B. In one example, gesture manager 106 uses a point of reference shown at 204 as a “star” to determine the distance in which the two fingers have been moved. It will be understood that the star may or may not be displayed in user interface 104.

Gesture manager 106 determines the amount of the distance that the two fingers are moved and then uses the distance to determine how fast to move the media. For example, if a video is being played in user interface 104, gesture manager 106 determines a video seek speed based on the distance the two fingers have been moved, such as a video seek speed for the first distance shown in FIG. 2B may be a 2× speed from a normal play speed and the video seek speed for the second distance shown in FIG. 2C may be a 4× speed. In one embodiment, gesture manager 106 may compare the distance detected to a look up table to determine the seek speed. For example, a distance in the range of 0.1-0.5 inches is a 2× seek speed, a distance in the range of 0.5-1.0 inches is a 4× speed, and so on.

Once the seek speed is determined, particular embodiments may continue to seek with the determined seek speed until a gesture to stop seeking is received. For example, once a user moves the two fingers a certain distance, gesture manager 106 determines that a seek command has been received. Then, once the movement of the two fingers has stopped, gesture manager 106 determines the distance of the movement and a corresponding seek speed. Gesture manager 106 then causes the video to start seeking at the determined speed. In one example, gesture manager 106 may wait until the user has stopped moving the two fingers to calculate the distance and the seek speed. In other embodiments, gesture manager 106 may increase the seek speed as the user continually moves the two fingers across user interface 104. For example, when the user starts moving the two fingers, the seek speed is increased to 2×. When the user moves the two fingers past the 0.5 inch distance, the seek speed is increased to 4×, and so forth.

The seeking may continue even when the user has stopped moving the two fingers across user interface 104. For example, in FIG. 2B, the video continues to be played at the 2× speed, and in FIG. 2C, the video continues to be played at the 4× speed. This continues until gesture manager 106 receives a stop seek command. For example, gesture manager 106 may detect that the user has removed one or both of the two fingers. Other stop seek commands may also be used, such as the user may select a stop button, move the fingers in another direction, or touch the screen with another finger. Once gesture manager 106 detects the stop seek command, gesture manager 106 causes the video to stop seeking, thus returning the video to the normal playback speed.

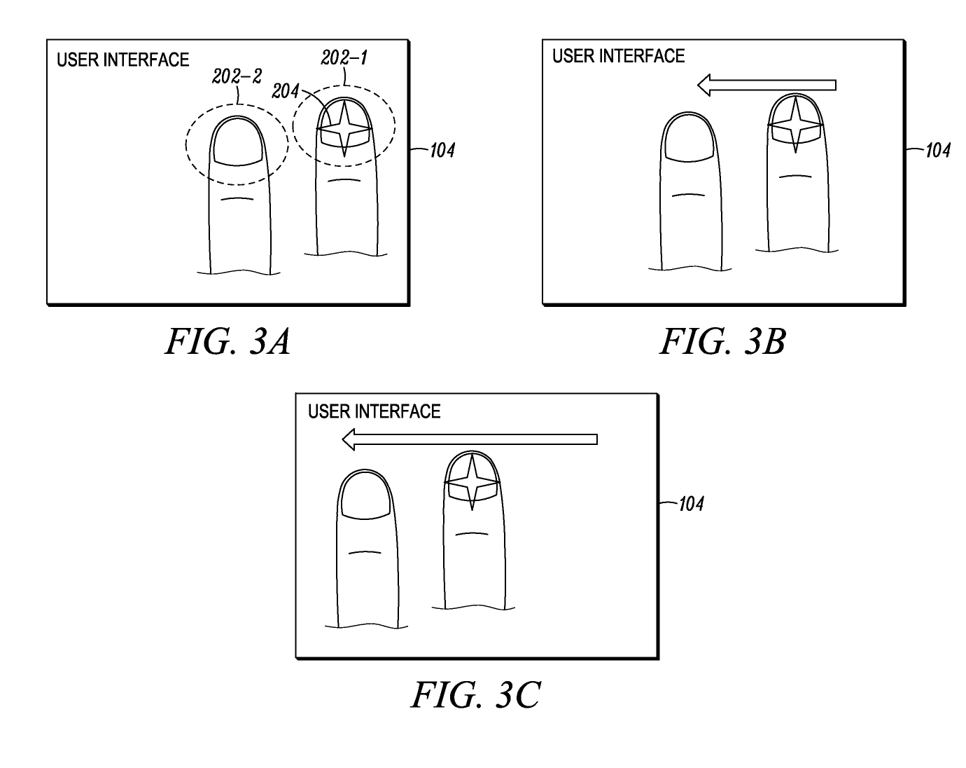

FIGS. 3A-3C depict examples for causing movement of media in a different direction from that of FIGS. 2A-2C according to one embodiment. In FIG. 3A, the user has touched user interface 104 in areas 202-1 and 202-2. Additionally, at 204, a point of reference is designated as a star.

In FIG. 3B, a user has moved the two fingers across user interface 104 a first distance in the left direction and in FIG. 3C, the user has moved the two fingers across user interface 104 a second distance in the left direction. As described above, gesture manager 106 analyzes the distance of the movement. Additionally, gesture manager 106 uses the direction of the movement to determine the direction of the seek operation. In FIGS. 2A-2C, the direction was to the right and gesture manager 106 determines that this causes a seek operation in the forward direction of the video. In FIGS. 3A-3C, the direction of the movement of the two fingers is to the left and gesture manager 106 determines a seek operation for the video should be in the backwards direction (i.e., rewind). Although this correlation of direction of movement of the two fingers to a forward or rewind operation is discussed, other correlations may be used, such as an upward direction causes a forward seek operation. Also, although a seek operation is discussed, the multi-touch gesture may be used to control other functions, such as a volume of the media may be turned up or down at a certain speed.

In another embodiment, the user may be requesting movement of media other than a video. For example, user interface 104 may be displaying a document, which can be any information, such as a word processing document, web page, e-mail, etc. In FIGS. 2A-2C, gesture manager 106 may cause the document to be scrolled in a horizontal direction to the right. Also, if the document cannot be scrolled to the right, the document may be scrolled in another direction, such as downward. In FIG. 2B, the scrolling may be performed at a first speed to the right and in FIG. 2C, the scrolling may be performed at a second speed to the right where the second speed is faster than the first speed. Additionally, in FIG. 3B, the scrolling may be to the left at a first speed and in FIG. 3C, the scrolling may be to the left at a second speed. Again, the second speed is greater than the first speed. Although not shown, the fingers may be moved in other directions, such as in the upward direction, circular motion, elliptical motion or downward direction, for example. In this case, gesture manager 106 analyzes the distance of the movement of the two fingers and determines a different scrolling speed in the upward direction or downward direction.

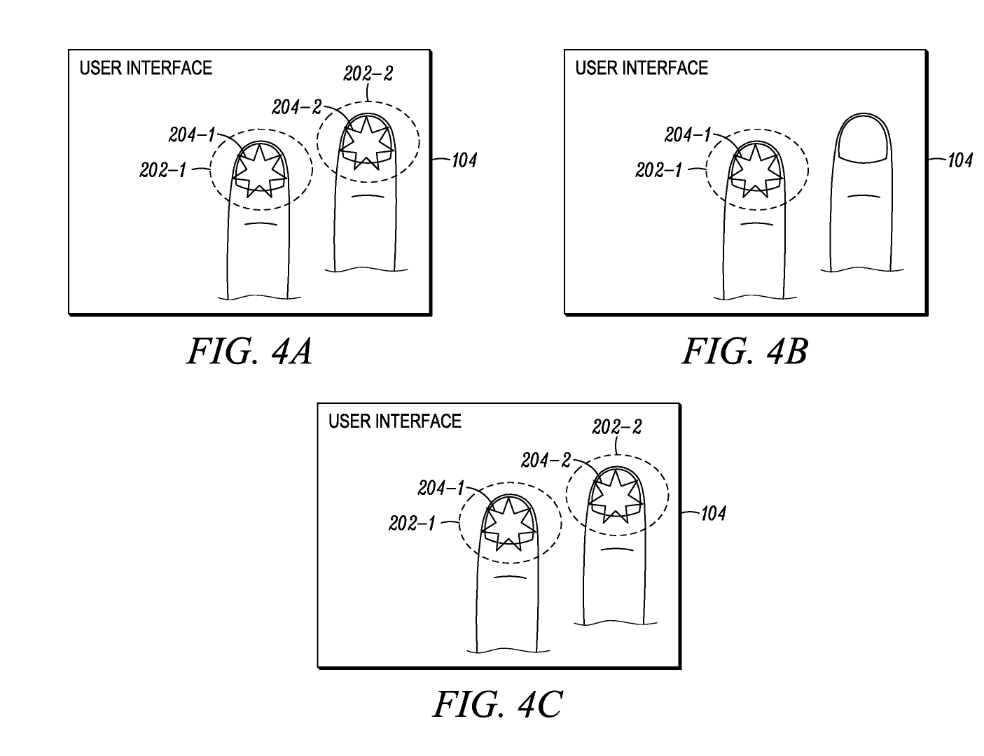

In another embodiment, the user may provide a multi-touch gesture to move the media a number of units. For example, the multi-touch gesture may be used to move a video forward a pre-defined time period, such as one second. The video then may resume a normal playback speed or may be put in a paused state. FIGS. 4A-4C depict an example of a multi-touch gesture for moving media a number of units according to one embodiment. In FIG. 4A, a user has touched user interface 104 in areas 202-1 and 202-2. At 204-1 and 204-2, a symbol of a “star” depicts whether or not a user is contacting or touching user interface 104. If a star is present, then the user is touching user interface 104 and if a star is not present, a user is not touching user interface 104.

It is noted that the multi-touch gesture in FIGS. 4A-4C is performed without any movement of the fingers across user interface 104. In this case, a user keeps the two fingers stationary. However, the multi-touch gesture may also be a sequence of touches. For example, in FIG. 4B, a user has removed a second right finger from user interface 104. In this case, a user keeps a left finger touching user interface 104. In one example, gesture manager 106 determines that the removal indicates that the user wants to move the media a number of units. However, an additional gesture may need to be performed by the user to cause the movement of the media. For example, FIG. 4C depicts an example where the user has moved the right finger to again touch user interface 104. Thus, the user has performed a sequence of touches on user interface 104 by touching user interface 104 with two fingers, removing one finger, and touching user interface 104 again with two fingers. When gesture manager 106 detects this sequence, gesture manager 106 causes the media to move a number of units. For example, gesture manager 106 causes the video to move forward one second. Additionally, if scrolling of a document is being performed, the scrolling of information displayed in the document, such as a list, may be scrolled to the right one unit. For example, if there are a list of 10 items in the document, focus may be on the first item. Then, the second item may be selected upon receiving the gesture. In another example, the display of the document may be shifted to the left by one unit (simulating moving a scroll bar to the right one unit).

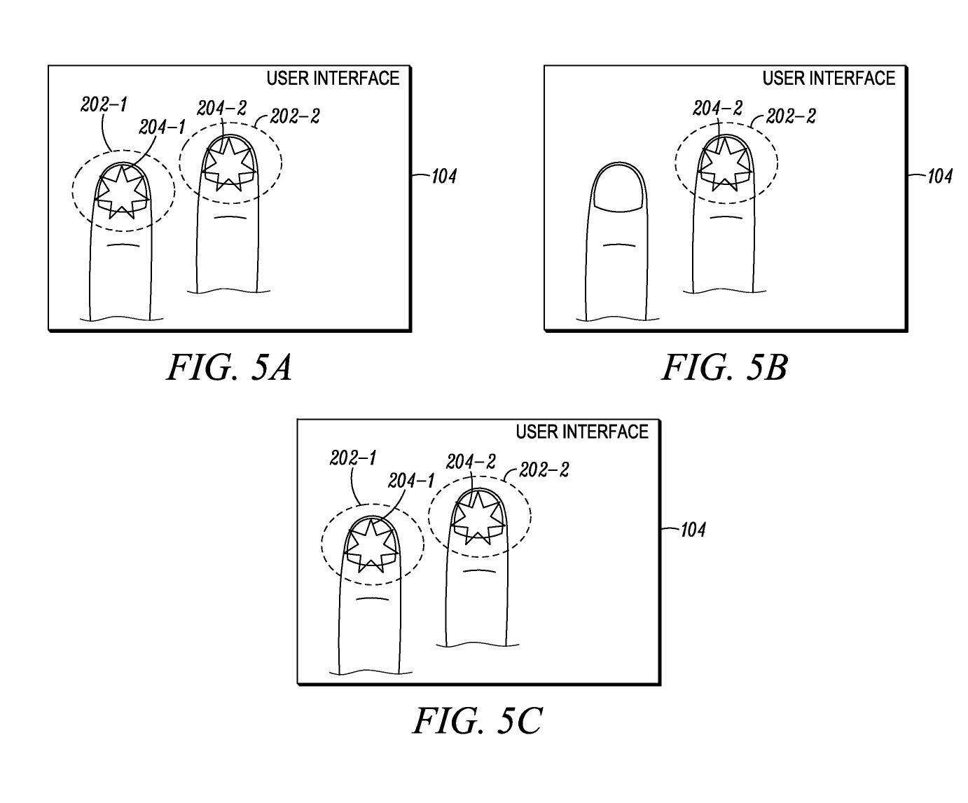

FIGS. 5A-5C depict another example of using a multi-touch gesture to move the media a number of units according to one embodiment. The difference between FIGS. 5A-5C and FIGS. 4A-4C is that a user removes a different finger from user interface 104. For example, the user removes the left finger instead of the right finger in FIGS. 5A-5C. In this case, this indicates that the user desires to move the video in a different direction than that in FIGS. 4A-4C. For example, removing the left finger indicates to gesture manager 106 that the user desires to move media in a left direction. For example, gesture manager 106 causes a video to move backwards one second. Also, gesture manager 106 may cause scrolling of a document one unit to the left.

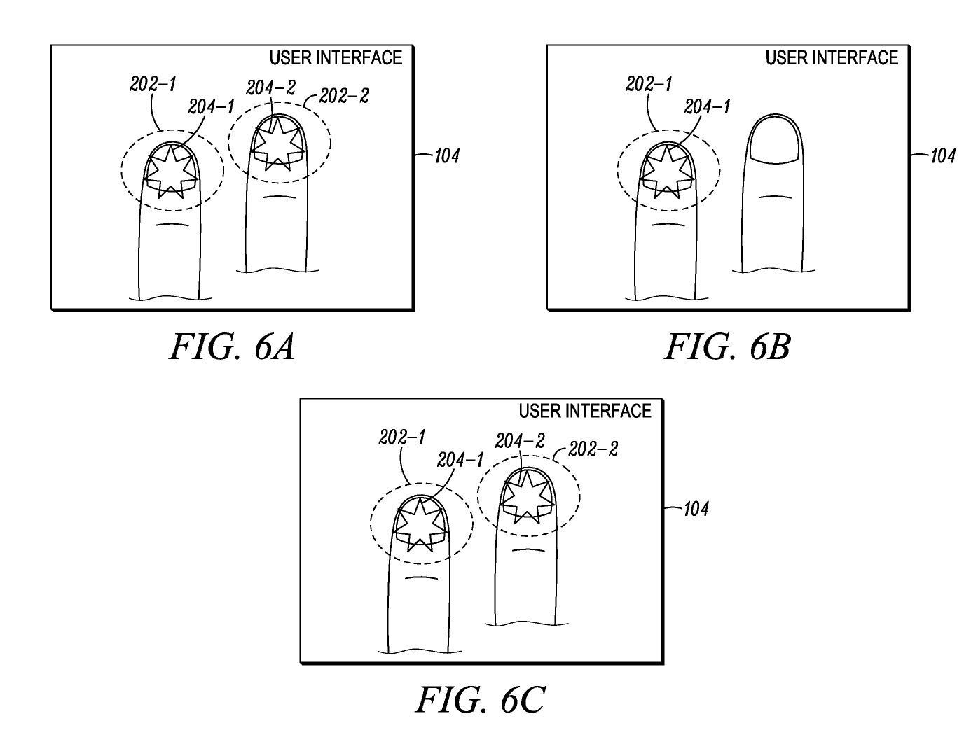

If the document can be scrolled in the up or down direction, a variation of the multi-touch gesture shown in FIGS. 4A-4C and 5A-5C may be used. FIGS. 6A-6C depict an example for performing scrolling of a document in an upward direction according to one embodiment. In FIG. 6A, a user has touched user interface 104 with two fingers in areas 202-1 and 202-2. In one example, the user may indicate that scrolling in the upward direction is desired by positioning the two fingers to touch user interface 104 where area 202-2 is above area 202-1. For example, area 202-2 may be above area 202-1 by a certain threshold. In one example, positioning area 202-2 above area 202-1 indicates a desire to scroll upward. In FIG. 6B, a user removes one of the fingers, such as the right finger. In FIG. 6C, the user may replace the right finger to touch user interface 104. Gesture manager 106 interprets the sequence as an indication to scroll the document (or list) upward for a number of units.

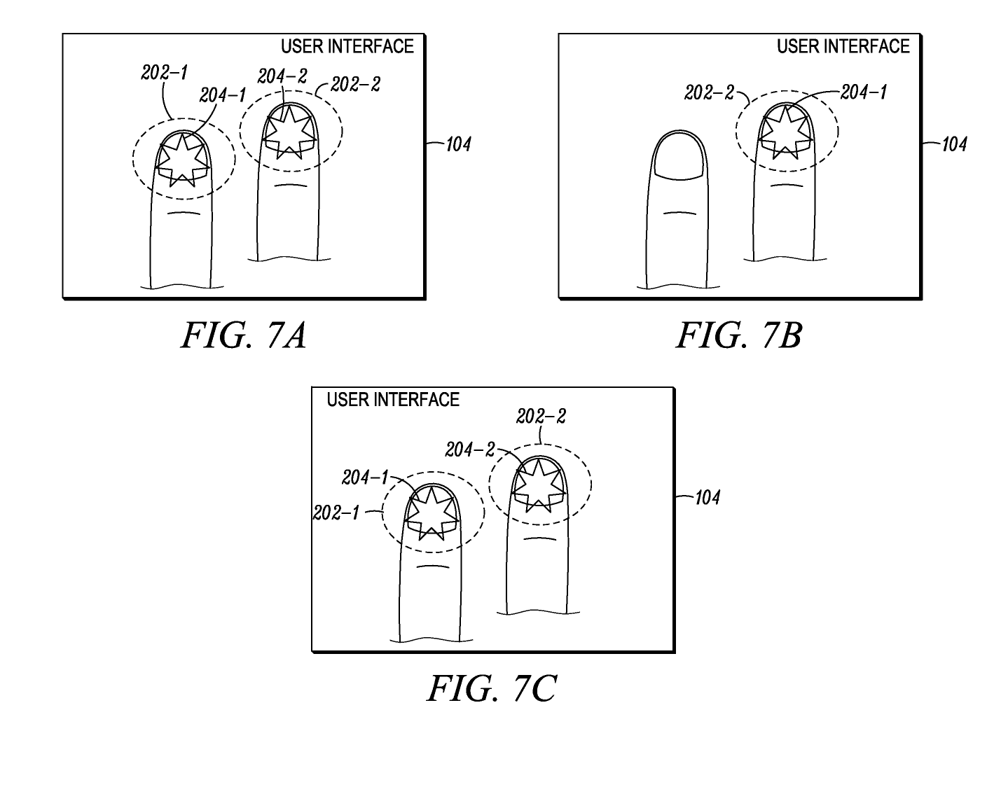

FIGS. 7A-7C depict another example of a sequence of a multi-touch gesture used to indicate a downward direction of scrolling according to one embodiment. In this case, FIG. 7A depicts the user touching user interface 104 with two fingers in areas 202-1 and 202-2. In this example, the left finger is below the right finger. In FIG. 7B, a user has removed a left finger from user interface 104 and then replaced the finger on user interface 104 in FIG. 7C. In one embodiment, gesture manager 106 interprets this sequence as indicating the user wants to scroll downward a number of units.

Although the above sequences were described, it will be understood that other combinations of placing the left and right fingers at different positions may be used to indicate scrolling upwards or downwards. Further, the number of units may vary depending on the sequence detected. For example, a user may touch more fingers on user interface 104 to indicate a larger number of units are desired. Also, continuing to remove and touch user interface 104 may indicate additional units to move the media.

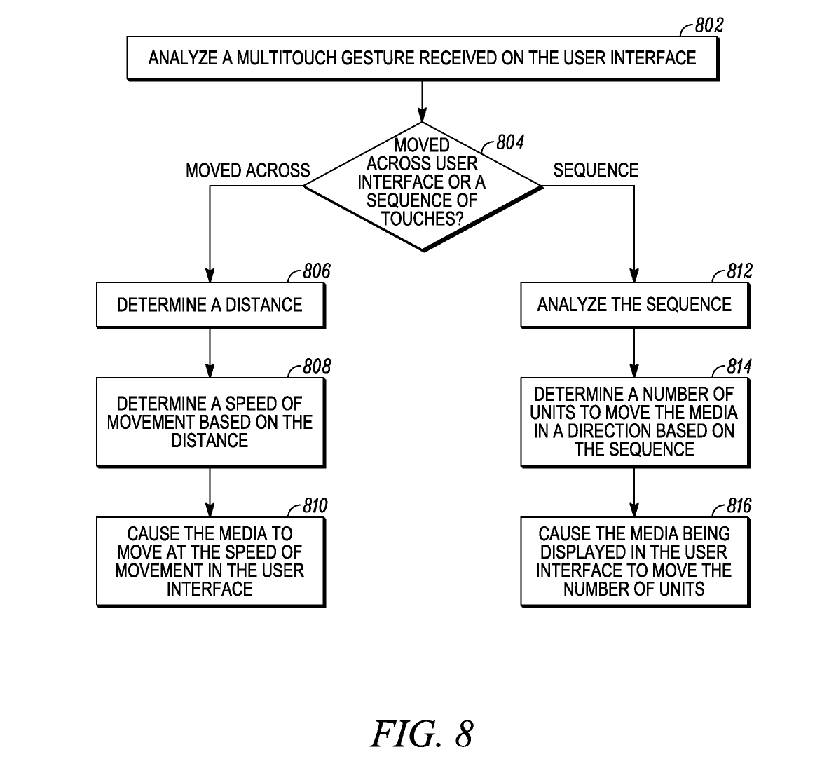

FIG. 8 depicts a simplified flowchart 800 of a method for analyzing multi-touch gestures according to one embodiment. At 802, gesture manager 106 analyzes a multi-touch gesture received on user interface 104. At 804, gesture manager 106 determines if the multi-touch gesture is moved across user interface 104 or is a sequence of touches.

At 806, if the multi-touch gesture is moved across user interface 104, gesture manager 106 determines a distance that the multi-touch gesture is moved across user interface 104. For example, a point of reference is used for one of the fingers that is touching user interface 104 to determine the distance. At 808, gesture manager 106 determines a speed of movement for the media based on the determined distance. The speed of movement is a speed in which to move media being displayed on user interface 104. At 810, gesture manager 106 causes the media being displayed on user interface 104 to move at the determined speed of movement. For example, a seek operation for a video in the forward or backward direction is performed or a document may be scrolled in a certain direction.

If gesture manager 106 determines that a sequence of touches was received, at 812, gesture manager 106 analyzes the sequence. For example, a user may touch user interface 104 with two fingers, remove one of the fingers, and place the same finger down again on user interface 104.

At 814, gesture manager 106 determines a number of units to move the media in a direction based on the sequence detected. For example, the sequence may indicate that the media should be moved one unit in a certain direction, such as a video should be moved forward or backward one second or a document should be scrolled in the left, right, up, or down direction one unit as described above. At 816, gesture manager 106 causes the media being displayed on user interface 104 to move the number of units.

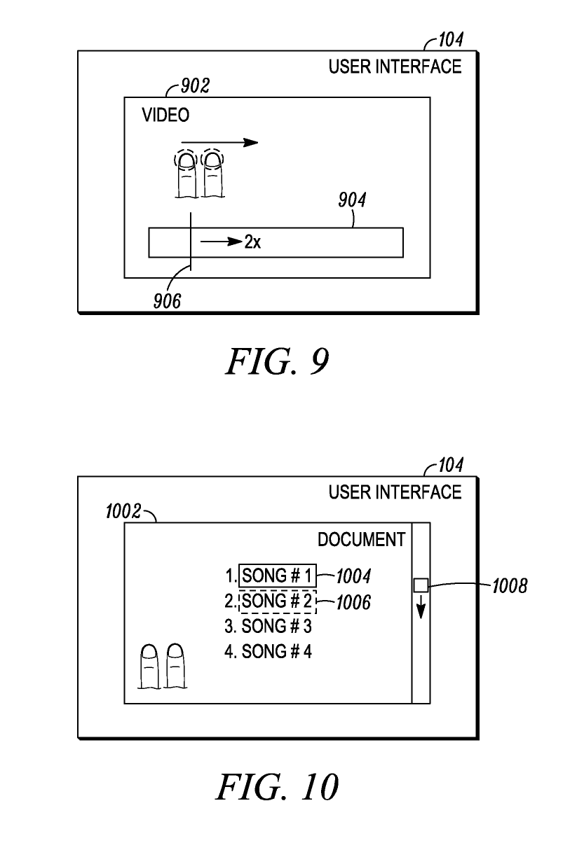

FIG. 9 depicts an example of a result of performing one of the multi-touch gestures shown in FIG. 2A-2C or 3A-3C according to one embodiment. As shown, user interface 104 is playing a video 902. A user may perform a gesture anywhere on user interface 104. For example, the user touches an area that is playing video 902 on user interface 104 and moves the two fingers across user interface 104.

At 904, a timeline for the length of the video is shown. The timeline includes a status bar 906 that indicates a current time at which the video is being played. As a result of the gesture, the video seeks forward at a 2× speed. In this case, status bar 906 is moved across timeline 904 at a 2× speed in conjunction with the video being played at a 2× speed.

It should be noted that the user may use a multi-touch gesture on different areas of user interface 104. For example, the user can contact any position in user interface 104. This may be different from a user having to touch status bar 906 and move the status bar to a different position in the timeline as conventionally was used to perform a seek. By allowing a user to contact different areas of user interface 104, the user may more easily provide a seek command rather than attempting to touch status bar 906, which may be very small when compared to a user's fingers.

In another example not shown, the user may perform a sequence as described above with respect to FIGS. 4A-4C and 5A-5C. In this case, video 902 may be moved a unit forward or backward.

FIG. 10 depicts a result of a multi-touch gesture shown in FIGS. 4A-4C, 5A-5C, 6A-6C, and 7A-7C according to one embodiment. In one example, a document 1002 includes a list of items 1-4. For example, the list may include a list of songs. At 1004, a current focus may be on a first item #1, e.g., a first song may be selected and is playing. A user may perform a gesture in which a sequence is performed. For discussion purposes, it is assumed the sequence indicates that the user wants to scroll down a unit. In this case, at 1006, the focus has been shifted to item #2, e.g., a second song is selected and begins playing. In other embodiments, the user may want to scroll in a downward direction at a certain speed. In this case, the user may perform a gesture that causes the document to scroll downward at a speed, such as a 2× speed. In one example, a scroll bar 1008 is scrolled downward to scroll document 1002 in the downward direction. In another embodiment, a seek operation on the selected song 1004 may be performed to advance forward into the song, for example, or temporarily pause a song. Other operations are contemplated as well for controlling playback of the media content with gestures anywhere on the user interface and not only in a pre-designated touch zone that may be small for most user's inputs.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The computer system may include one or more computing devices. The instructions, when executed by one or more computer processors, may be operable to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. The above examples and embodiments should not be deemed to be the only embodiments, and are presented to illustrate the flexibility and advantages of particular embodiments as defined by the following claims. Based on the above disclosure and the following claims, other arrangements, embodiments, implementations and equivalents may be employed without departing from the scope hereof as defined by the claims.

What is claimed is:

1. A method comprising:
detecting, by an electronic device, a multi-touch gesture on a touch input area associated with the electronic device, wherein the multi-touch gesture is moved across the touch input area;
determining, by the electronic device, a distance that the multi-touch gesture is moved across the touch input area;
determining, by the electronic device, a speed of movement based on the determined distance; and
causing, by the electronic device, movement of media being displayed in the electronic device at the determined speed of movement based on detecting the multi-touch gesture on the touch input area.

2. The method of claim 1, wherein detecting the multi-touch gesture comprises:
detecting a first touch of a first object on the touch input area;
detecting a second touch of a second object on the touch input area; and
detecting movement of at least one of the first object and the second object across the touch input area.

3. The method of claim 2, wherein determining the distance comprises determining the distance that the at least one of the first object and the second object is moved across the touch input area.

4. The method of claim 1, wherein movement of the media comprises seeking at the speed of movement in a video.

5. The method of claim 1, wherein movement of the media comprises scrolling at the speed of movement in a document.

6. The method of claim 1, further comprising detecting a direction that the multi-touch gesture moves across the touch input area, wherein the movement of the media is in a direction based on the detected direction.

7. The method of claim 1, wherein different distances that the multi-touch gesture is moved across the touch input area cause different speeds of movement to be determined.

8. The method of claim 1, wherein the touch input area includes part of a user interface displaying the media.

9. The method of claim 1, wherein the movement of media continues after stopping of the multi-touch gesture until a stop movement gesture is received.

10. A method comprising:
detecting, by an electronic device, a first touch of a first object on a touch input area associated with the electronic device;
detecting, by the electronic device, a second touch of a second object on the touch input area associated with the electronic device;
determining, by the electronic device, a sequence of touches received from the first object and the second object;
analyzing, by the electronic device, the sequence of touches to determine a number of units; and
causing, by the electronic device, movement of media being displayed in the electronic device for the number of units based on analyzing of the sequence.

11. The method of claim 10, further comprising:
determining a removal of one of the first touch and the second touch from the touch input area; and
determining a third touch after removal of the one of the first touch and the second touch from the touch input area; and
upon determining the third touch, causing movement of media for the number of units.

12. The method of claim 11, wherein the number of units is in a direction based on which of the one of the first touch and the second touch was removed.

13. The method of claim 10, wherein movement of the media comprises seeking the number of units in a video.

14. The method of claim 10, wherein movement of the media comprises scrolling the number of units in a document.

15. The method of claim 10, wherein an offset of positioning of the first touch and the second touch is used to determine a direction of movement.

16. An apparatus comprising:
one or more computer processors; and
a non-transitory computer-readable storage medium comprising instructions that, when executed, control the one or more computer processors to be configured for:
detecting a multi-touch gesture on a touch input area, wherein the multi-touch gesture is moved across the touch input area;
determining a distance that the multi-touch gesture is moved across the touch input area;
determining a speed of movement based on the determined distance; and
causing movement of media being displayed at the determined speed of movement based on detecting the multi-touch gesture on the touch input area.

17. The apparatus of claim 16, wherein different distances that the multi-touch gesture is moved across the touch input area cause different speeds of movement to be determined.

18. The apparatus of claim 16, wherein the movement of media continues after stopping of the multi-touch gesture until a stop movement gesture is received.

19. An apparatus comprising:
one or more computer processors; and
a non-transitory computer-readable storage medium comprising instructions that, when executed, control the one or more computer processors to be configured for:
detecting a first touch of a first object on a touch input area;
detecting a second touch of a second object on the touch input area;
determining a sequence of touches received from the first object and the second object;
analyzing the sequence of touches to determine a number of units; and
causing movement of media being displayed for the number of units based on analyzing of the sequence.

20. The non-transitory computer-readable storage medium of claim 19, further configured for:
determining a removal of one of the first touch and the second touch from the touch input area; and
determining a third touch after removal of the one of the first touch and the second touch from the touch input area; and
upon determining the third touch, causing movement of media for the number of units.
